(19) United States
(12) Patent Application Publication
(10) Pub. No.: US 2013/0245592 A1
(43) Pub. Date: Sep. 19, 2013

(54) CHLOROBUTYL RUBBER-BASED SELF-RESEALING SEPTUM AND CLOSURE ASSEMBLY

(71) Applicant: FISHER SCIENTIFIC COMPANY L.L.C., Hampton, NH (US)

(72) Inventors: John T. Glaser, Hawthorne, NJ (US); Mark Jasko, River Edge, NJ (US)

(73) Assignee: FISHER SCIENTIFIC COMPANY L.L.C., Hampton, NH (US)

(21) Appl. No.: 13/795,546

(22) Filed: Mar. 12, 2013

Related U.S. Application Data
(60) Provisional application No. 61/612,153, filed on Mar. 16, 2012.

(51) Int. Cl. A61J 1/14

(52) U.S. Cl. CPC A61J 1/1406
USPC 604/415; 215/341; 428/215

(57) ABSTRACT

A self-resealing septum useful in a closure assembly for a container for storing non-aqueous liquids is provided. The septum having a laminate structure including a first layer of a resilient material derived from chlorobutyl rubber and a second layer of a non-elastic polymer. The self-resealing closure assembly includes the septum and a retaining mechanism that is useful for a container assembly that contains a non-aqueous liquid comprising an organic solvent, a liquid organic compound, a water-reactive or oxygen-reactive compound, or a combination thereof.

### CROSS-REFERENCE TO RELATED APPLICATIONS

This application claims the filing benefit of U.S. Provisional Patent Application Ser. No. 61/612,513, filed Mar. 16, 2012, the disclosure of which is hereby incorporated herein by reference in its entirety.

### FIELD OF THE INVENTION

This invention relates generally to septa, and more particularly to a penetrable and self-resealing septum and closure assembly, which can be used for storing non-aqueous liquids in the chemical, medical, and biochemical industries.

### BACKGROUND OF THE INVENTION

Septa are piercable, mechanical barriers typically positioned between a vessel and its contents (usually a liquid) and the vessel's ambient environment. In such a configuration, a septum prevents contamination of the vessel contents and/or contamination of the environment by the vessel contents. The ability of the septum to maintain this separation is important for non-aqueous solvents and chemical reagents, especially hygroscopic or reactive reagents that require isolation from ambient laboratory conditions. For example, non-aqueous solvents such as dimethylsulfoxide and acetone can readily absorb atmospheric moisture upon exposure, and reactive reagents such as organolithium reagents can readily react with oxygen and atmospheric moisture. As such, for extended storage capability, it is important that a septum maintains its ability to prevent contamination after an initial piercing by a member such as a small gauge tube.

A typical septum is generally comprised of resilient material, pressed or otherwise inserted into a rigid collar, such as a vessel neck or cap so as to hold the elastomer under radial compression. Depending on the nature of the vessel contents, the septum may be optionally coated on one or both sides by an inert polymer such as a fluoropolymer, which are generally inelastic as compared to the resilient material.

When pierced by a small gauge tube, the resilient material creates a seal around the tube with a radial reaction force. When the tube is withdrawn, the resilient material forces the hole closed to form a substantially contiguous closed condition, thus, resealing the vessel. In the event that the septum is coated with an inert polymer material on the vessels content side of the septum, the tube generally leaves a hole that does not substantially close thereby permitting exposure of the resilient material to the vessel's contents.

Accordingly, in order to provide extended storage capability, the resilient material making up the septum needs to demonstrate compatibility with the vessel's contents. Because the chemical reactivity properties of non-aqueous solvents and chemical reagents are highly variable and dependent on their specific identity, often times many different types of resilient materials need to be tested and matched according to the resilient material's non-reactivity with the solvents or reagents. Often times the match is less than ideal, resulting in a premature breakdown of the contiguous closed hole, which permits contact between the vessel's contents and the ambient air.

Based on the foregoing, there is a need for a septum comprising a single species of resilient material that demonstrates broad compatibility with non-aqueous solvents and chemical reagents, and is simple to fabricate.

### SUMMARY OF THE INVENTION

The present invention overcomes the foregoing and other shortcomings and drawbacks of re-sealing septa and closure assemblies heretofore known. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a septum for use in a self-resealing closure assembly for a container is provided. The septum, which is suitable for closing an opening in a container, enables storing non-aqueous liquids, such as organic solvents, liquid organic compounds, water-reactive or oxygen-reactive compounds, or combinations thereof. The septum is particularly designed to provide re-sealing properties to containers after having been punctured by a hollow member, such as a needle, to preserve a separation of the non-aqueous liquid from the ambient environment outside of the container.

In one embodiment, a septum for use in a self-resealing closure assembly for a container is provided. The septum is a laminate structure penetrable by a member in an axial direction and a portion of the laminate structure is configured to elastically distend to pass the member through a tear in the septum and to be self-closing by returning opposite edges of the tear to a substantially contiguous closed condition after withdrawal of the member and which maintains a seal following member penetration in an axial direction and withdrawal. The septum includes a first layer of a resilient material derived from halobutyl rubber, such as chlorobutyl rubber, and having first and second opposed surfaces, and a second layer of a non-elastic polymer extending across, and bonded to, the first surface of the first layer. The first layer has a thickness within the range from about 2 mm to about 10 mm. The second layer has a thickness within the range from about 0.03 mm to about 1 mm.

In an embodiment, a self-resealing closure assembly for a container is provided, the assembly enables storing non-aqueous liquids, such as organic solvents, liquid organic compounds, water-reactive or oxygen-reactive compounds, or combinations thereof. The self-resealing closure assembly includes a septum, a retaining mechanism of inelastic material for supporting the septum, and a cap of inelastic material. The septum is particularly designed to provide re-sealing properties to containers after having been punctured by a hollow member, such as a needle, to preserve a separation of the non-aqueous liquid from the ambient environment outside of the container.

In one aspect of the self-resealing closure assembly, the septum is a laminate structure penetrable by a member in an axial direction and a portion of the laminate structure is configured to elastically distend to pass the member through a tear in the septum and to be self-closing by returning opposite edges of the tear to a substantially contiguous closed condition after withdrawal of the member and which maintains a seal following member penetration in an axial direction and withdrawal. The septum includes a first layer of a resilient material derived from a halobutyl rubber, such as chlorobutyl rubber, and having first and second opposed surfaces, and a second layer of a non-elastic polymer extending across, and bonded to, the first surface of the first layer.

In another aspect of the self-resealing closure assembly, the retaining mechanism of inelastic material has an inner and an outer surface, wherein the inner surface of the retaining mechanism is configured to make closing engagement with a rim of the container, and wherein the septum is supported in an opening defined in the retaining mechanism. In a further aspect, the cap of inelastic material configured to engage with the outer surface of the container or the retaining mechanism.

In another aspect of embodiments of the present invention, a method of preserving a non-aqueous liquid in a container is provided, the method includes storing the non-aqueous liquid within a self-resealing container assembly according to embodiments of the present invention.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 illustrates in partial perspective view a self-resealing non-aqueous liquid container assembly in accordance with an embodiment of the present invention;

FIG. 2 illustrates in perspective view a disassembled self-resealing closure assembly of the self-resealing non-aqueous liquid container assembly shown in FIG. 1;

FIG. 3 illustrates in perspective view a puncturable septum for the disassembled self-resealing closure assembly shown in FIG. 2;

FIG. 3A is a cross-sectional view taken along line 3A-3A in FIG. 3 depicting the puncturable septum in the self-resealing closure assembly of FIG. 2;

FIG. 4 is a partial transverse cross-sectional view of the self-resealing non-aqueous liquid container assembly shown in FIG. 1; and

FIG. 5 is a partial transverse cross-sectional view of a self-resealing non-aqueous liquid container assembly according to an embodiment of the present invention.

### DETAILED DESCRIPTION OF EMBODIMENTS OF THE INVENTION

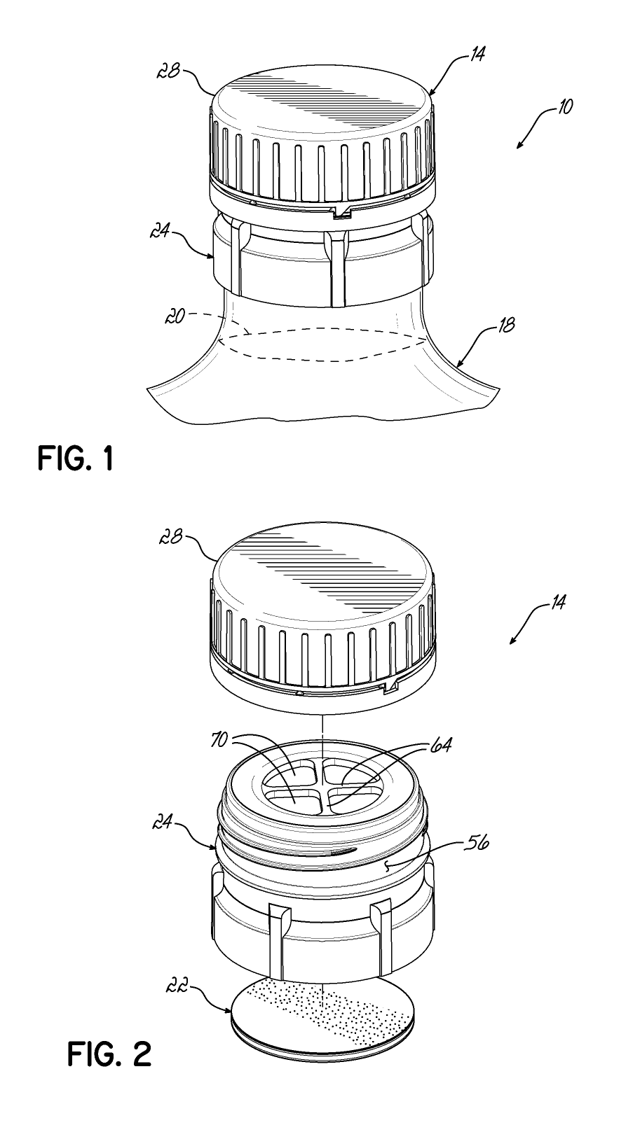

Referring now to the figures, and to FIG. 1 in particular, an improved self-sealing non-aqueous liquid container assembly 10 is shown in accordance with an embodiment of the present invention. The container assembly 10 generally includes a self-sealing closure assembly 14 affixed to a container 18 that contains a non-aqueous liquid 20, as shown in the illustrated embodiment. As shown in FIG. 2, the self-sealing closure assembly 14 generally includes a septum 22, a retaining mechanism 24 for the septum that is configured to make a closing engagement with a rim of the container, as well as to support the septum 22, and a cap 28 configured to engage with an outer surface of the retaining mechanism 24. In an alternative embodiment (not shown), the cap 28 may be configured to engage with container 18.

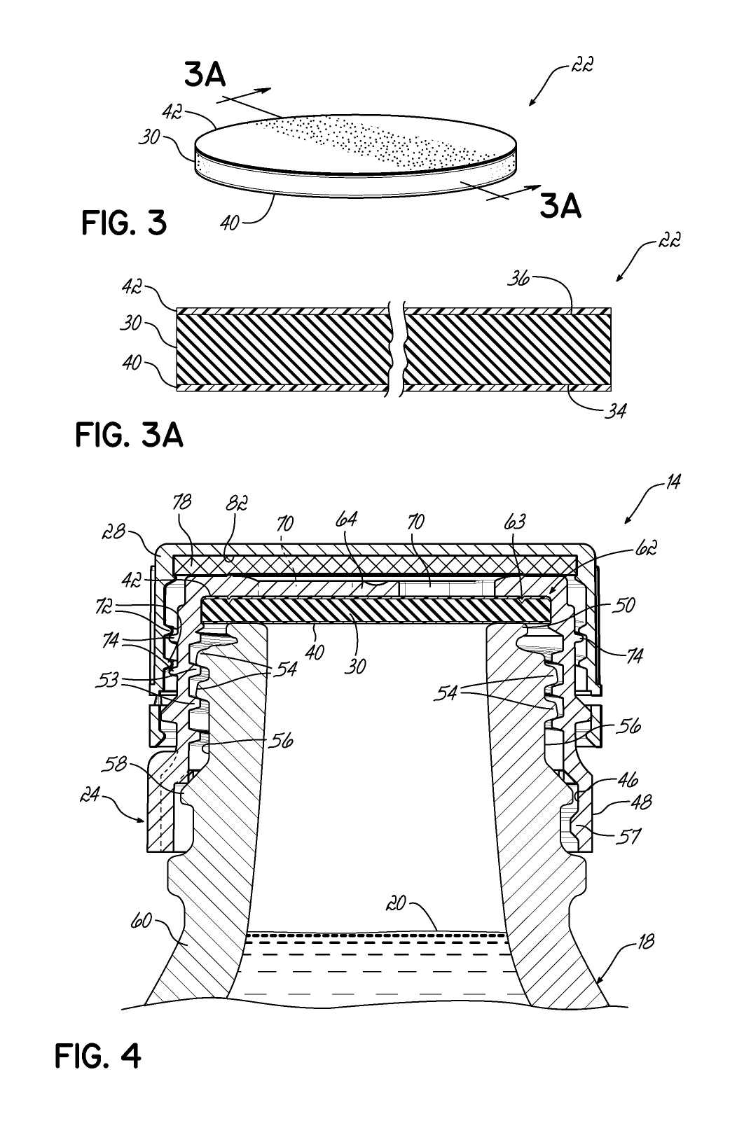

According to embodiments of the present invention, the septum 22 is a laminate structure including a first layer 30 of a resilient material having a first surface 34 and a second surface 36, where the first and the second surfaces 34, 36 are opposing surfaces, and a second layer 40 of a non-elastic polymer extending across, and bonded to, the first surface 34 of the first layer 30. According to an embodiment shown in FIG. 3A, which is a cross-sectional view taken along line 3A-3A of FIG. 3, the septum 22 further comprises a third layer 42 of a non-elastic polymer extending across, and bonded to, the second surface 36 of the first layer 30, such that the first layer 30 of resilient material is sandwiched between two layers 40, 42 of non-elastic polymers.

According to embodiments of the present invention, the resilient material is derived from a halobutyl rubber, such as a chlorobutyl rubber. As used herein, the phrase “chlorobutyl rubber” refers to a chlorinated butyl elastomer. Chlorinated butyl elastomers suitable for use in the embodiments of the present invention include, but are not limited to, those elastomers obtained by chlorination of butyl rubber, which is a copolymer of an isoolefin, and a co-monomer such as a C₄ to C₆ conjugated diolefin co-monomer or an alkyl-substituted vinyl aromatic co-monomer. An exemplary isoolefin includes isobutene. An exemplary conjugated diolefin co-monomer includes isoprene, and an exemplary vinyl aromatic co-monomer includes C₁-C₄-alkyl substituted styrene. Examples of chlorinated butyl elastomers that are commercially-available include chlorinated isobutene-isoprene copolymer (CIIR), or chlorinated isobutene-methylstyrene copolymer (CIMS).

Chlorinated butyl elastomers typically contain in the range of from 0.1 to 10 weight percent, for example 0.5 to 5 weight percent, of repeating units derived from the diolefin, and in the range of from 90 to 99.9 weight percent, for example 95 to 99.5 weight percent, of repeating units derived from the isoolefin, based upon the hydrocarbon content of the polymer, and in the range of from 0.1 to 9 weight percent, for example from 0.75 to 2.3 weight percent, chlorine, based upon the chlorobutyl polymer. According to an embodiment, the chlorinated butyl elastomer comprises isobutene and isoprene. A typical chlorinated butyl elastomer has a molecular weight, expressed as the Mooney viscosity according to DIN 53 523 (ML 1+8 at 125° C.), in the range of from 25 to 60.

The resilient material can also include commonly used additives such as stabilizers and fillers. Suitable stabilizers include calcium stearate and epoxidized soy bean oil, which may be present in an amount in the range of from 0.5 to 5 parts by weight per 100 parts by weight of the chlorinated butyl rubber (phr). Suitable fillers include, for example, kaolin, titanium dioxide, carbon blacks, such as those carbon blacks that can be prepared by the lamp black, furnace black or gas black process and have BET specific surface areas of 20 to 200 m²/g, for example, SAF, ISAF, HAF, FEF or GPF carbon blacks. According to an exemplary embodiment, the chlorobutyl rubber-based resilient material may comprise white kaolin filler, titanium dioxide, and carbon N600, available from Gummi-Wöhleke GmbH—Siemensstraβe 25-D-31135 Hildesheim (CIIR).

According to an embodiment, the first layer 30 of resilient material has a thickness in the range from about 1 mm to about 10 mm. For example, the thickness of the first layer 30 may be about 1 mm, about 2 mm, about 3 mm, about 4 mm, about 5 mm, about 6 mm, about 7 mm, about 8 mm, about 9 mm, or about 10 mm. In one aspect, the thickness of the first layer 30 may be uniform. Alternatively, the thickness of the first layer 30 may be greater in a central portion, or greater in the periphery, of the septum 22. According to an embodiment, the thickness of the first layer is about 3 mm and is substantially uniform.

According to embodiments of the present invention, the second layer 40 of a non-elastic polymer is positioned toward the non-aqueous liquid contents side of the septum 22. Insofar as the second layer 40 can be directly contacted by the non-aqueous liquid 20 of the container 18, the non-elastic polymer should be selected so as to be compatible with any of the non-aqueous liquids to which septum 22 may be exposed in its intended use. In other words, the non-elastic polymer should be a substantially chemically inert polymer. Accordingly, suitable non-elastic polymers for the second layer 40 include fluoropolymers, such as a polytetrafluoroethylene (PTFE), a (perfluoroalkoxy) fluoropolymer (PFA), and a fluorinated ethylene-propylene polymer (FEP). Exemplary fluoropolymers include, but are not limited to, TEFLON®, TEFLON® PFA, and TEFLON® FEP, which are commercially available from E. I. DuPont de Nemours and Company, Wilmington, Del. Other brand names for PFA granules are Neoflon® PFA from Daikin or Hyflon® PFA from Solvay Solexis. PFA is characterized as having properties similar to that of polytetrafluoroethylene (PTFE), but PFA differs from the PTFE resins in that it is generally melt-processable using conventional injection molding and screw extrusion techniques. PFA and FEP both share PTFE's useful properties of low coefficient of friction and non-reactivity, but are more easily formable. For example, PFA is softer than PTFE and melts at 305° C. According to one embodiment, the non-elastic polymer is a (perfluoroalkoxy) fluoropolymer (PFA).

According to another embodiment, the septum 22 further comprises a third layer 42 of a non-elastic polymer extending across, and bonded to, the second surface 36 of the first layer 30, such that the first layer 30 of resilient material is sandwiched between two layers of non-elastic polymers. The third layer 42 of a non-elastic polymer is positioned away from the non-aqueous liquid contents side of the septum 22, i.e., toward the ambient environment. Accordingly, non-elastic polymers suitable for the third layer 42 are not generally limited by their chemical reactivity with the non-aqueous liquid. However, according to an embodiment of the present invention, the third layer 42 may comprise fluoropolymers, such as a polytetrafluoroethylene, a (perfluoroalkoxy) fluoropolymer, and a fluorinated ethylene-propylene polymer, and thereby not unnecessarily confine the septum 22 to a single orientation. According to an embodiment, the second and third layer 40, 42 comprise the same fluoropolymer.

According to embodiments of the present invention, the second and/or third layer 40, 42 have a thickness less than about 1 mm. According to one embodiment, the thickness is within the range from about 0.03 mm to about 1 mm. For example, the thickness of the second layer 40 or the third layer 42 may be independently about 0.03 mm, about 0.05 mm, about 0.1 mm, about 0.15 mm, about 0.2 mm, about 0.25 mm, about 0.5 mm, or about 1 mm.

The laminate structure of the septum 22 can be fabricated in any of a number of ways. One such way includes bonding the three layers together with a flexible adhesive or other suitable means, such as stitching or heat pressing. Alternatively, where the non-elastic polymer can be provided as a liquid, the polymer may be applied to the first and/or second surface 34, 36 of the first layer 30 by spray coating or extruding the non-elastic polymer onto the first layer 30 of resilient material. The bonded non-elastic material assists the resilient material in providing self-resealing properties.

With reference to FIG. 4 and in accordance with embodiments of the present invention, the septum 22 can be used in combination with a retaining mechanism 24 of inelastic material having an inner 46 and an outer 48 surface. The inner surface 46 of the retaining mechanism 24 is configured to make closing engagement with a rim 50 of the container 18, and optionally, the outer surface 48 can be configured to make closing engagement with cap 28. Accordingly, the retaining mechanism 24 may be generally tubular in shape with internal threading 53 provided on the inner surface 46 of the retaining mechanism 24 to provide frictional engage with complementary threading 54 on an outer surface 56 of container 18. The retaining mechanism 24 can further include a protruding member 57, which provides obstructive interference with a complementary protruding member 58 on the outer surface 60 of the container 18, should removal of the retaining mechanism 24 be attempted.

The septum 22 is supported in an opening 62 defined in the retaining mechanism 24. The retaining mechanism 24 is adapted to support the septum 22 and thereby facilitate direct and intimate contact between the second layer 40 of the septum 22 and the rim 50 of the container 18, which provides the necessary barrier between the non-aqueous liquid and the surrounding atmosphere. Accordingly, the opening 62 is configured to provide a snug fit of the septum 22 in the opening 62. According to the embodiment shown in FIG. 4, the inner surface 46 of the retaining mechanism 24 can further include a raised portion 63 that is axially disposed above the rim 50 and provides frictional retention of the septum 22 between the retaining mechanism 24 and the rim 50 upon tightening of the retaining mechanism 24 onto the container 18. This frictional interference provided by the compressional deformation of the third layer 42 of the septum 22 by the raised portion 63 maintains the septum 22 within the opening 62 during application of downward axial force by a puncturing member, such as a needle.

Complementary support is provided to the septum 22 by the cross-member 64, which is defined by apertures 70 in the retaining mechanism 24 that are axially disposed above the septum 22. The cross-member 64 prevents deflection of the septum 22 when withdrawing the puncturing member from the septum 22, or if the internal pressure of the container exceeds ambient pressure.

According to an embodiment of the present invention, a cap 28 of inelastic material is configured to engage with the outer surface 48 of the retaining mechanism 24. In an alternative embodiment (not shown), the cap 28 can be configured to engage with a complementary configuration of the outer surface 48 of the container 18. In continued reference to FIG. 4, the cap 28 is provided with internal threading 72, which provides frictional engage with complementary threading 74 on the outer surface 48 of retaining mechanism 24. The cap 28 may further include an outer cap liner 78 positioned at the upper inner surface 82 of the cap, which upon tightening of the cap 28 onto the retaining mechanism 24 provides a secondary level of closure to the container 18 beyond the septum 22. The outer cap liner 78 may be a disc formed of a foamed fluoropolymer. Thus, according to the embodiment shown in FIG. 4, the septum 22, the retaining mechanism 24, and the cap 28 are generally concentrically circular.

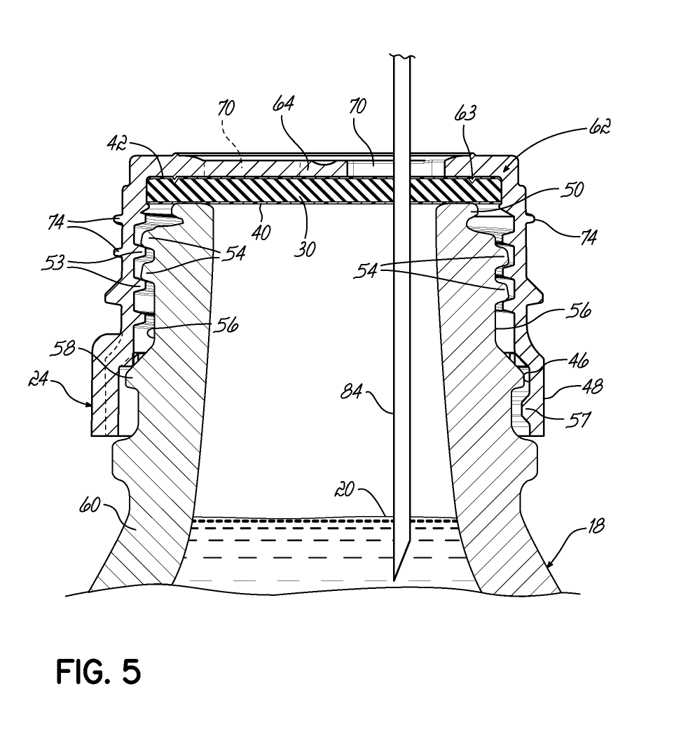

In reference to FIG. 5, a needle 84 is shown entering the septum 22 through aperture 70 into a volume of the container 18 to gain access to the non-aqueous liquid 20 for retrieval of a sample of the liquid.

Self-resealing closure assemblies and self-resealing container assemblies in accordance with the principles of the present invention are suitable for the extended storage of non-aqueous liquids, especially after an initial puncture of the septum 22. As used herein, “non-aqueous liquids” refers to liquids that are not water-based and do not contain water that has been intentionally added. However, adventitious presence of water is not excluded. For example, non-aqueous liquids may contain an amount of adventitious water equal to or less than about 100 parts per million (ppm). For particular solvents or other liquids, the suitable or preferred levels can be higher or lower. Non-aqueous liquids include, but are not limited to, organic solvents, liquid organic compounds, a water-reactive or oxygen-reactive compound, or combinations thereof. For example, non-aqueous liquids also include organic solvent solutions or mixtures comprising water-reactive or oxygen-reactive compounds.

Exemplary organic solvent classes include alcohols, amides, amines, aromatic amines, esters, ethers, hydrocarbons, halogenated hydrocarbons, ketones, nitriles, or sulfoxides. Exemplary organic solvents include, but are not limited to, acetone, acetonitrile, chloroform, diethyl ether, dimethylacetamide, dimethylformamide, dimethylsulfoxide, dioxane, ethanol, ethyl acetate, hexane, methanol, N-methylpyrrolidinone, pyridine, tetrahydrofuran, or toluene.

Exemplary liquid organic compounds include amines such as diethyl amine, benzyl amine, or ethanolamine; aldehydes such as acetaldehyde or crotonaldehyde; or phosphines such as tri-n-butylphosphine.

Exemplary water-reactive or oxygen reactive compounds include organometallic compounds, boranes, hydrides, Lewis acids, or acid halides. Organometallic compounds include, but are not limited to, organomagnesium compounds, organolithium compounds, organoaluminum compounds, or organozinc compounds. Exemplary organomagnesium compounds, which are also commonly known as Grignard reagents, include methylmagnesium bromide, phenylmagnesium bromide, methylmagnesium iodide, or phenylmagnesium chloride. Exemplary organolithium compounds include n-butyllithium, ethyllithium, phenyllithium, or tert-butyllithium. Exemplary organoaluminum compounds include diethylaluminum chloride, diisobutylaluminum chloride, or triethylaluminum. Exemplary organozinc compounds include diethyl zinc or dimethyl zinc.

Exemplary boranes include diethylmethoxyborane or tributylborane. Exemplary hydrides include diisobutylaluminum hydride or lithium aluminum hydride. Exemplary Lewis acids include boron tribromide or tin chloride. Exemplary acid halides include acetyl chloride. Other chemical reagents that may also be stored using the assemblies and methods disclosed herein also include bromine in acetic acid, or hydrogen chloride in ethanol.

Isotopic analogs of the foregoing non-aqueous liquids are also envisaged. For example, non-aqueous liquids also include deuterated nuclear magnetic resonance (NMR) solvents, such as acetone-d6, acetonitrile-d3, deuterium oxide, dichloromethane-d2, methanol-d4, dimethylsulfoxide-d6, or toluene-d8.

Thus, according to another embodiment of the present invention, a method of preserving a non-aqueous liquid in a container is provided. The method includes storing the non-aqueous liquid within the self-resealing container assemblies described above. For example, the herein described self-resealing container assemblies may inhibit the absorption of ambient moisture by hygroscopic non-aqueous liquids.

According to embodiments of the invention, a member, such as a hollow member in the form of a needle 84, may penetrate septum 22 in axial direction to provide or remove contents to/from container 18. The septum 22, and more specifically the first layer 30 of resilient material of the septum 22, maintains a seal around the puncturing member, and re-closes to maintain the seal in container 18 when the member is withdrawn from septum 22.

Accordingly, the assemblies and methods disclosed herein provide acceptable compatibility with the non-aqueous liquids, as well as provide improved isolation of the non-aqueous liquid from the external ambient environment and thereby provide protection against adventitious water absorption or absorption. In one aspect, for an non-aqueous liquid having an initial water content, the self-resealing container assembly may provide less than about 100% increase in water content above the initial water content after storage of the container assembly at ambient conditions for extended durations after a single occurrence of puncturing the septum with an 18 gauge needle and retracting the 18 gauge needle.

In one embodiment, for an non-aqueous liquid having an initial water content equal to or less than about 100 ppm, the self-resealing container assembly may provide less than about 100% increase in water content above the initial water content after storage of the container assembly at ambient conditions for 6 weeks after a single occurrence of puncturing the septum with an 18 gauge needle and retracting the 18 gauge needle. In another embodiment, the self-resealing container assembly may provide less than about 100% increase in water content above the initial water content after storage of the container assembly at ambient conditions for 7 weeks, 8 weeks, or more.

In another aspect, the initial water content may be equal to or less than 75 ppm, or equal to or less than 50 ppm.

In another aspect, the increase in water content over the testing period may be less than about 75%, less than about 50%, or less than about 25% above the initial water content.

The present invention is illustrated by the following examples that are merely for the purpose of illustration and are not to be regarded as limiting the scope of the invention or the manner in which it can be practiced.

### EXAMPLES

Comparative testing: Various septa, e.g., black Viton, red Viton, FKM, silicon, red SO203583T, may be tested for comparison to a septum comprising a resilient material derived from a halobutyl rubber, such as chlorobutyl rubber. Each septum is coated on a single side or on two sides with a fluoropolymer. The septum is placed in a retainer mechanism, which is subsequently affixed to a bottle containing a non-aqueous liquid, such as an organic solvent, a liquid organic compound, a water-reactive or oxygen-reactive compound, or a combination thereof. The fluoropolymer coated side is positioned toward the non-aqueous liquid. The septum is pierced with an 18 gauge needle and bottle assembly is inverted several times to simulate normal laboratory usage. The physical integrity of the pierced septa is visually evaluated.

For example, testing of various septa coated on a single side with a layer of a fluoropolymer against exemplary organic solvents may be performed, where each septum is placed in a retainer mechanism, which is subsequently affixed to a bottle containing a dry organic solvent (e.g., acetonitrile (ACN), dichloromethane (DCM), diethyl ether (DEE), tetrahydrofuran (THF), and toluene (TOL)). Two bottles for each septa and solvent are prepared, with one bottle being subjected to the following experimental testing regime: After the initial filling and sealing of the solvent container, each septum is pierced three times with an 18 gauge needle affixed to a syringe. For this testing protocol, the first puncture rinses the syringe, and either the second or the third puncture sample may be tested for water content. This puncturing protocol may be performed at weekly intervals with the physical integrity of the septum and the inversion test being performed each week. The water content may also be tested at weekly intervals, with the unpierced bottle being tested at the conclusion of the testing period.

According to one exemplary testing protocol, a chlorobutyl and an ethylene propylene diene monomer (EPDM) septa may be tested for comparison. Exemplary septum include, but are not limited to, EPDM bright one side 0.1 mm PTFE coating; Chlorobutyl grey with 0.25 mm PFA foil coating; Chlorobutyl black with 0.25 mm PFA foil coating; and EPDM bright 0.05 mm PFA coating with dark primer.

According to another exemplary testing protocol, the testing of single sided chlorobutyl rubber-based septa, (e.g., a single faced black chlorobutyl (supplier GW Silicones of Royalton, Vt.); and a single faced chlorobutyl grey coated with Fluorotec® Dalkyo fluoro resin D, B2-40, Westar® RS (supplier Adelphi Healthcare Packaging of West Sussex, UK) may be tested, where two ×30 ml bottles of each solvent filled using the two septa types, with one bottle of each solvent/septa combination being pierced once on day 0. The other samples remain unpierced until the completion of the testing period (week 7). Pierced septa may be visually examined each week and re-tested for water content on week 7. Unpierced septa may be pierced and solvent tested on final week (7) for comparison. Organic solvents analyzed may include acetone, diethylether (DEE), methanol (MeOH), dichloromethane (DCM), dimethylformamide (DMF), and tetrahydrofuran (THF), for example.

According to another exemplary testing protocol, the puncturing protocol describe above may be performed using an 18 gauge needle on a dual coated chlorobutyl rubber-based septa (double side coated CB, 0.25 PFA; Gummi-Wöhleke GmbH—Siemensstraβe 25-D-31135 Hildesheim) in combination with exemplary organic solvents, such as acetone, diethylether (DEE), methanol (MeOH), dichloromethane (DCM), dimethylformamide (DMF), and tetrahydrofuran (THF) to demonstrate the ability of the dual coated chlorobutyl rubber-based septa to inhibit the absorption of water.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. The invention in its broader aspects is, therefore, not limited to the specific details, representative apparatus and method, and illustrative examples shown and described. Accordingly, departures may be made from such details without departing from the spirit or scope of the general inventive concept.

Having described the invention, we claim:

1. A septum for use in a self-resealing closure assembly for a container containing a non-aqueous liquid, the septum having a laminate structure comprising:
a first layer of a resilient material derived from halobutyl rubber and having first and second opposed surfaces, wherein the first layer has a first layer thickness between the first and second opposed surfaces within the range from about 1 mm to about 10 mm; and
a second layer of a first non-elastic polymer extending across, and bonded to, the first surface of the first layer, wherein the second layer has a second layer thickness within the range from about 0.03 mm to about 1 mm, wherein the laminate structure of the septum is penetrable by a member in an axial direction and a portion of the laminate structure being configured to elastically distend to pass the member through a tear in the septum and to be self-closing by returning opposite edges of the tear to a substantially contiguous closed condition after withdrawal of the member and which maintains a seal following member penetration in an axial direction and withdrawal, and wherein the septum is used for closing an opening in the container.

2. The septum of claim 1 wherein the first layer is in an initially unbroken condition and the tear is made by rupturing the first layer with the member.

3. The septum of claim 1 further comprising a third layer of a second non-elastic polymer extending across, and bonded to, the second surface of the first layer, wherein the first and the second non-elastomeric polymer are the same or different.

4. The septum of claim 3, wherein at least one of the first non-elastomeric polymer of the second layer, or the second non-elastic polymer of the third layer comprises a fluoropolymer.

5. The septum of claim 4, wherein the fluoropolymer is selected from the group consisting of a polytetrafluoroethylene, a (perfluoroalkoxy) fluoropolymer, and a fluorinated ethylene-propylene polymer.

6. The septum of claim 4, wherein the fluoropolymer is a (perfluoroalkoxy) fluoropolymer.

7. The septum of claim 1, wherein the halobutyl rubber is a chlorobutyl rubber.

8. A self-resealing closure assembly for a container, comprising:
the septum of claim 1, and
a retaining mechanism of inelastic material having an inner and an outer surface, wherein the inner surface of the retaining mechanism is configured to make closing engagement with a rim of the container, and wherein the septum is supported in an opening defined in the retaining mechanism.

9. The self-resealing closure assembly of claim 8, further comprising:
a cap of inelastic material configured to engage with the container or the outer surface of the retaining mechanism.

10. A self-resealing container assembly comprising:
a container;
a non-aqueous liquid comprising an organic solvent, a liquid organic compound, a water-reactive or oxygen-reactive compound, or a combination thereof; and
a self-resealing closure assembly for the container, comprising the septum of claim 1.

11. The container assembly of claim 10, further comprising:
a retaining mechanism of inelastic material having an inner and an outer surface, wherein the inner surface of the retaining mechanism is configured to make closing engagement with a rim of the container, and wherein the septum is supported in an opening defined in the retaining mechanism; and
a cap of inelastic material configured to engage with the container or the outer surface of the retaining mechanism.

12. The container assembly of claim 10, wherein the organic solvent is selected from the group consisting of alcohols, amides, amines, aromatic amines, esters, ethers, hydrocarbons, halogenated hydrocarbons, ketones, nitriles, and sulfoxides.

13. The container assembly of claim 10, wherein the organic solvent is selected from the group consisting of acetone, acetonitrile, chloroform, diethyl ether, dimethylacetamide, dimethylformamide, dimethylsulfoxide, dioxane, ethanol, ethyl acetate, hexane, methanol, N-methylpyrrolidinone, pyridine, tetrahydrofuran, and toluene.

14. The container assembly of claim 10, wherein the non-aqueous liquid comprises a solution or mixture of the organic solvent, and the water-reactive or oxygen-reactive compound, wherein the water-reactive or the oxygen-reactive compound is selected from the group consisting of organometallic compounds, boranes, metal hydrides, Lewis acids, and acid halides.

15. The container assembly of claim 14, wherein the organometallic compound is selected from the group consisting of an organomagnesium compound, an organolithium compound, an organoaluminum compound, and an organozinc compound.

16. The container assembly of claim 10, wherein the liquid organic compound is selected from the group consisting of amines, aldehydes, and phosphines.

17. The container assembly of claim 10, wherein an initial water content of the non-aqueous liquid is equal to or less than about 100 ppm, and wherein after a single occurrence of puncturing the septum with an 18 gauge needle and retracting the 18 gauge needle, the self-resealing container assembly providing less than about 100% increase in water content above the initial water content after storage of the container assembly at ambient conditions for 6 weeks.

18. The container assembly of claim 17, wherein the initial water content is equal to or less than 75 ppm.

19. The container assembly of claim 17, wherein the initial water content is equal to or less than 50 ppm.

20. The container assembly of claim 17, wherein the increase in water content is less than about 50% above the initial water content.

21. The container assembly of claim 17, wherein the increase in water content is less than about 25% above the initial water content.

22. A method of preserving a non-aqueous liquid in a container comprising:
storing the non-aqueous liquid within the self-resealing container assembly of claim 10.
